(19) United States
(12) Patent Application Publication
(10) Pub. No.: US 2024/0273169 A1
(43) Pub. Date: Aug. 15, 2024

(54) USER VALIDATION USING ENCODED DATA

(71) Applicant: Kazutaka Oba, John's Creek, GA (US)

(72) Inventor: Kazutaka Oba, John's Creek, GA (US)

(73) Assignee: Ricoh Company, Ltd., Tokyo (JP)

(21) Appl. No.: 18/108,004

(22) Filed: Feb. 9, 2023

(51) Int. Cl. G06F 21/31; G06K 19/06

(52) U.S. Cl. CPC G06F 21/31; G06K 19/06018

(57) ABSTRACT

An approach is provided for validating the identity of a user using encoded data, such as a QR code, or the like, that contains user identification information, such as biometric information and non-biometric information, and specifies one or more validation methods to validate the user identification information. An identity validation manager provides functionality that allows users to register user identification information and generate encoded data. A user scans the encoded data at a computing device, such as a kiosk, that either validates the user identification information locally or via the identity validation manager. The approach allows users to self-validate at stand-alone computing devices, such as kiosks, using only the encoded data without having to present other forms of identification, such as government issued documents, etc. Implementations include the encoded data specifying one or more location and/or time constraints, and the encoded data optionally being encrypted.

### FIELD

The technical field of this patent application relates to validating the identity of users using encoded data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Validating the identity of users occurs in a wide variety of situations. For example, the identity of users is often validated before being allowed access to public transportation, such as airlines, or before being allowed access to government and business locations. Many government locations and private businesses require users to present identification, such as a driver's license, passport, other documents, etc., that is manually verified at a security checkpoint.

More recently, these processes have been streamlined using biometric technology. For example, a user's biometric information, such as face information, eye (iris, retina) information, fingerprint information, etc., is registered with a service that performs a background check. Once the background check has been successfully completed, the user's biometric information is collected at security checkpoint and verified against the registered biometric information. While this approach can reduce the amount of time required to pass through security checkpoints, it does not allow offline verification or flexibility in the biometric information used for verification. There is, therefore, a need for a technical solution to the problem of how to validate user identities that avoids the limitations of prior solutions.

### SUMMARY

A computing device comprises one or more data acquisition components that are configured to acquire encoded data that contains first user identification information and data that specifies one or more validation methods to validate the first user identification information. The one or more data acquisition components are also configured to acquire second user identification information of a user at the computing device. The computing device is configured to cause the second user identification information to be validated using the first user identification information and the one or more validation methods.

A computing device comprises an identity validation service executing on the computing device. The identity validation service is configured to receive user identification information acquired by a second computing device from a user at the second computing device. The identity validation service is also configured to validate the user identification information acquired by the second computing device from the user at the second computing device using user identification information and one or more validation methods from encoded data. The aforementioned approaches may also be implemented by one or more computer-implemented processes and non-transitory computer-readable media that store instructions which, when processed by one or more processed, implement the approach.

### BRIEF DESCRIPTION OF THE DRAWINGS

Implementations are depicted by way of example, and not by way of limitation, in the figures of the accompanying drawings and in which like reference numerals refer to similar elements.

FIG. 1 is a block diagram that depicts an arrangement for validating the identity of a user using encoded data that contains user identification information and data that specifies one or more validation methods to validate the user identification data.

FIG. 2 depicts an example implementation of a computing device.

FIG. 3 is a block diagram that depicts an example implementation of an identity validation manager.

FIG. 4 is a message ladder diagram that depicts messages exchanged between the elements in arrangement to register user identification data and generate encoded data. during the creation of a secure print cloud job.

FIG. 5A depicts an example user management screen according to an implementation.

FIG. 5B depicts an example user edit screen that allows editing of current user data.

FIG. 5C depicts an example encoded data generation screen.

FIG. 6 is a message ladder diagram that depicts messages exchanged between elements to validate user identification data.

FIG. 7 is a block diagram that depicts an example computer system.

### DETAILED DESCRIPTION

In the following description, for the purposes of explanation, numerous specific details are set forth in order to provide a thorough understanding of the implementations. It will be apparent, however, to one skilled in the art that the implementations may be practiced without these specific details. In other instances, well-known structures and devices are shown in block diagram form in order to avoid unnecessarily obscuring the implementations.
I. Overview
II. Identity Validation Architecture
   A. Client Device
   B. Computing Device
   C. Identity Validation Manager
   D. Location Access System
III. Registering User Identification Data and Generating Encoded Data
IV. Validating User Identification Data
V. Implementation Examples

### I. OVERVIEW

An approach is provided for validating the identity of a user using encoded data that contains user identification information and specifies one or more validation methods to validate the user identification information. An identity validation manager provides functionality that allows users to register user identification information. As used herein, the term “user identification information” refers to any information that uniquely identifies a human being, also referred to herein as “a user.” Examples of user identification information include, without limitation, biometric information such as facial characteristics, eye (iris or retina) characteristics, fingerprints, palm prints, palm veins, hand geometry, Deoxyribonucleic acid (DNA), or voice information, non-biometric information such as a pass phrase, i.e., an alphanumeric string, or a Personal Identification Number (PIN), or any combination of biometric information and non-biometric information. Multiple types of user identification information may be registered for each user, for example, a user's facial information, iris or retina information, voice information and/or a pass phrase or PIN.

The identity validation manager generates encoded data that contains a portion or all of the registered user identification information for a user and specifies one or more validation methods to validate the user identification information. For example, the encoded data may contain biometric information for a user and non-biometric information, such as a pass phrase or a PIN. The encoded data may be any type of encoded data and the encoded data may be encoded using any encoding scheme. Example forms of encoded data include, without limitation, bar codes and Quick Response (QR) codes. Various implementations are depicted in the figures and described herein in the context of the encoded data being in the form of a QR code for purposes of explanation, but implementations are not limited to the encoded data being in the form of QR codes. The identity validation manager provides the encoded data to a user via a graphical user interface, via email, etc.

The user scans the encoded data at a computing device such as a kiosk, for example, by scanning a QR code at the computing device. The computing device extracts the user identification information and the one or more validation methods from the encoded data. The computing device then either validates the user identification information locally using the one or more validation methods, or sends the user identification information and data that specifies the one or more validation methods to the identity validation manager for validation.

The approach allows users to self-validate at stand-alone computing devices, such as kiosks, using only the encoded data without having to present other forms of identification, such as government issued documents, etc. The approach also provides great flexibility in the type of user identification information that is included in the encoded data, and it may vary depending upon a particular use or context. Implementations include the encoded data specifying one or more location and/or time constraints, and the encoded data optionally being encrypted. This allows the approach to be used in a wide variety of contexts, for example, to validate users for controlled access to buildings, entertainment venues, security checkpoints, etc., and for specific dates and/or times, e.g., for specific events.

### II. IDENTITY VALIDATION ARCHITECTURE

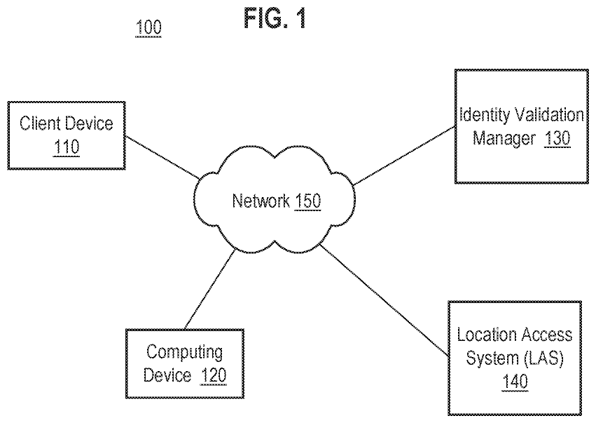

FIG. 1 is a block diagram that depicts an arrangement 100 for validating the identity of a user using encoded data that contains user identification information and data that specifies one or more validation methods to validate the user identification data. Arrangement 100 includes a client device 110, a computing device 120, an identity validation manager 130, and a Location Access System (LAS), communicatively coupled via a network 150. Arrangement 100 may include additional or fewer elements, depending upon a particular implementation, and not all of the elements depicted in FIG. 1 are required. The network 150 is implemented by any mechanism, such as wireless and/or wired networks that allow data to be exchanged between the elements of FIG. 1. The elements of FIG. 1 may also be communicatively coupled via one or more direct communications links that are not depicted in FIG. 1 for purposes of explanation.

### A. Client Device

The client device 110 may be implemented by any type of computing device. Examples of the client device 110 include, without limitation, a desktop or laptop computer, a personal digital assistant, a smart phone, etc. The client device 110 is configured to provide user access the functionality of the identity validation manager 130, such as registering user identification information on the identity validation manager 130 and generating encoded data for registered user identification information. The client device 110 may include various components, such as a Web browser, for accessing the identity validation manager 130. Although only a single client device 110 is depicted in FIG. 1 for explanation purposes, implementations are applicable to any number of client devices.

### B. Computing Device

The computing device 120 is a device that acquires, from a user, both the encoded data and user identification data. For example, a user scans, at the computing device 120, a QR code that contains user identification data and specifies one or more validation methods for validating the user identification data. The computing device 120 acquires user identification data for the user such as facial data, voice data, etc. The computing device 120 then validates the acquired user identification data either locally at the computing device 120 or remotely via the identity validation manager 130, as explained in more detail hereinafter.

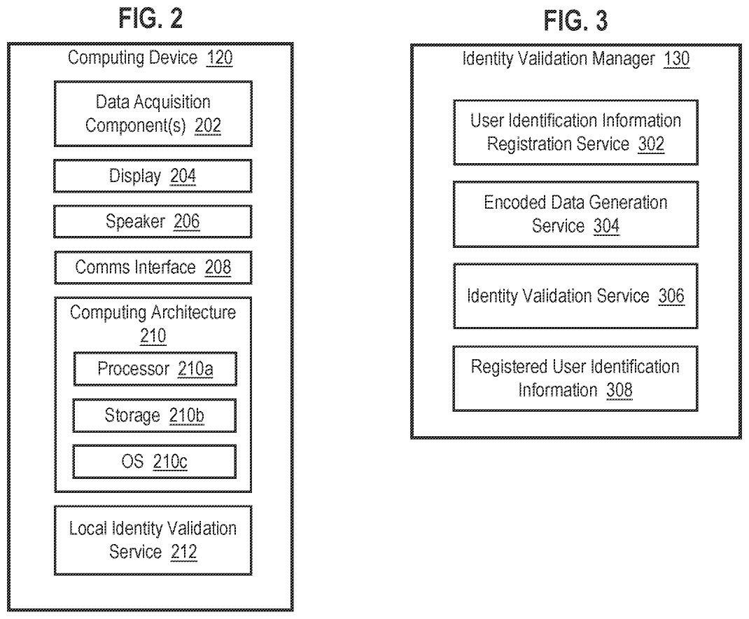

FIG. 2 depicts an example implementation of the computing device 120. In the example implementation of FIG. 2, the computing device 120 includes one or more data acquisition components 202 for acquiring the encoded data and the user identification from a user. Example implementations of the data acquisition components 202 include, without limitation, one or more cameras, scanners, a Near Field Communications (NFC) transmitter/receiver, microphones, input devices such keyboards, keypads, pointing devices such as mice, trackballs, etc. The computing device 120 may be configured with any number of data acquisition components 202. For example, the computing device 120 may include a scanner for scanning the QR code, a camera for acquiring an image of the user, a microphone for acquiring audio information from the user, and a keyboard or keypad to allow the user to enter a pass phrase or PIN. Many combinations of data acquisition, i.e., input devices, may be used and implementations are not limited to any particular combination of data acquisition components.

According to an implementation, the computing device 120 includes computer hardware, computer software, or any combination of computer hardware and software for supporting the data acquisition components 202. For example, the computing device 120 may include one or more services that support the operation of a scanner to scan QR codes and generate QR code data that represents the QR code. The services may also extract information from the QR code data to be used by the computing device 120 for identity validation, as described in more detail hereinafter.

In the example depicted in FIG. 2, the computing device 120 includes a display 204 for displaying information to the user and a speaker 206 for communicating audio information to the user. The computing device 120 optionally includes a communications interface 208, such as a wireless interface, a wired interface, etc., for communicating with other devices, such as the identity validation manager 130. Thus, the computing device 120 may operate as a stand-alone device, i.e., a kiosk, or as a networked computing device.

The computing device 120 includes a computing architecture 210 that supports the execution of various processes on the computing device 120. In the example depicted in FIG. 2, the computing architecture 210 includes a processor 210a, storage 210b, and an Operating System (OS) 210c. The processor 210a may be implemented by one or more microprocessors and associated computer hardware and/or computer software. The storage 210b may include any combination of volatile storage and non-volatile storage, such as Random Access Memory (RAM), solid state memory, one or more disks, etc. The Operating System (OS) 210c may be implemented by any type of OS that supports the execution of processes on the computing device 120. The computing architecture 210 may include fewer or additional elements that may vary depending upon a particular implementation.

The computing device 120 also includes a local identity validation service 212 for locally validating user identification data acquired by the computing device 120. The local identity validation service 212 validates the user identification data acquired by the computing device 120 using the user identification data contained the QR code and the one or more validation methods specified by the QR code.

### C. Identity Validation Manager

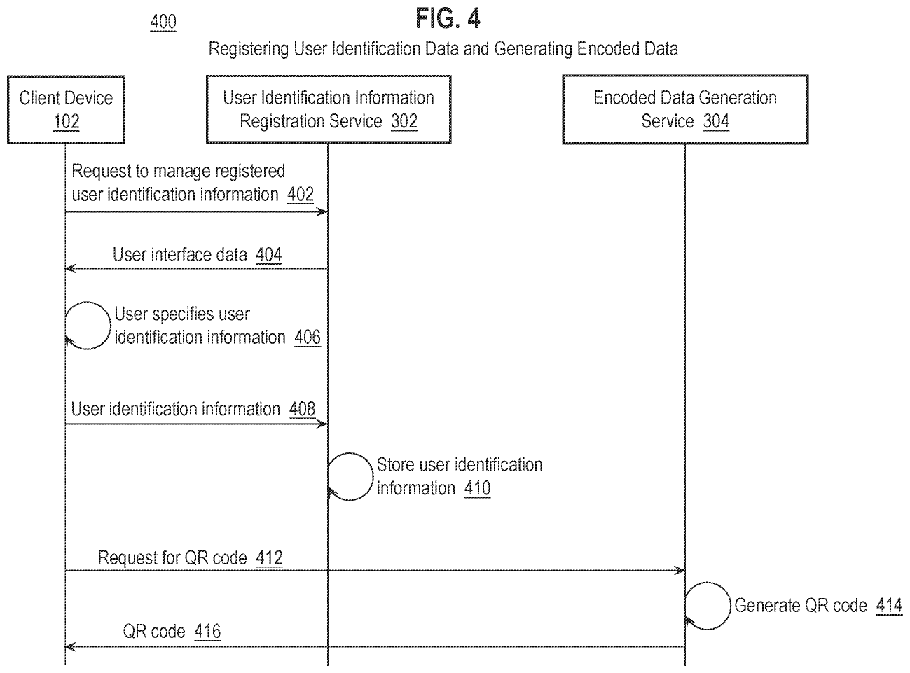

The identity validation manager 130 provides various services related to user identity validation according to the approaches described herein. FIG. 3 is a block diagram that depicts an example implementation of the identity validation manager 130. In this example, the identity validation manager 130 includes a user identification information registration service 302, an encoded data generation service 304, an identity validation service 306, and registered user identification information 308.

The user identification information registration service 302 allows users to register user identification information to be used for identity validation. The encoded data generation service 304 generates encoded data, for example in the form of a QR code, that contains user identification information and specifies one or more validation methods to validate the user identification information. As described in more detail hereinafter, according to an implementation the identity validation manager 130 includes a Web-based interface that provides a graphical user interface, e.g., via one or more Web pages, to the client device 110.

The identity validation service 306 validates user identification information using one or more validation methods that are designated to validate the user identification information. For example, as described in more detail hereinafter, when the computing device 120 scans a QR code that contains user identification information and the computing device 120 does not have the capability to validate the user identification information using the one or more validation methods specified by the QR code, the computing device 120 uses the identity validation service 306 to validate the user identification information. The computing device 120 generates and transmits a request to the identity validation service 306 to perform the validation. According to an implementation, the request specifies the user identification information and the one or more validation methods from the QR code, and user identification information acquired by the computing device 120 from a user, such as facial image data, voice data, etc. Alternatively, the request specifies the particular QR code that was scanned to enable the identity validation service 306 to lookup the user identification information and the one or more validation methods that were encoded in the QR code, without this information having to be included in the request. The identity validation service 306 validates the user identification information and provides a result of the validation to the computing device 120.

The registered user identification information 308 is data that specifies registered user identification information for multiple users. The particular user identification information registered may vary by user and the registered user identification information 308 may be stored in any format on local storage on the identity validation manager 130, or external to the identity validation manager 130.

According to an implementation, the identity validation manager 130 is implemented by one or more computing devices that support the services and data depicted in FIG. 3 and allow communication with the other elements of FIG. 1. This includes, for example, one or more processors and local storage, such as volatile and non-volatile memory, one or more communications interfaces, etc. The identity validation manager 130 may include fewer or additional elements that may vary depending upon a particular implementation. In addition, the functionality of the elements of FIG. 3 are depicted as being separate for purposes of explanation only and the functionality of the elements of FIG. 3 may be combined in any manner. In addition, the

[symbol]

### D. Location Access System

The Location Access System (LAS) 140 manages access to one or more locations based upon the results of user validation. According to an implementation, the LAS 140 manages access to one or more buildings based upon the results of user validation described herein. For example, upon successful validation of a particular user, either the computing device 120 or the identity validation manager 130, depending upon which entity performs the identity validation, notifies the LAS 140 of the successful validation of the particular user and in turn, the LAS 140 allows the particular user access to one or more locations, for example, one or more buildings of a business enterprise, one or more buildings of a government facility, or other entity, a venue, etc. Implementations are also applicable to the LAS 140 managing access to other types of locations, such as locker systems for secure package pickup. In this example, a locker system is configured with the computing device 120 or its components to allow the locker system to provide the user validation services described herein. Implementations are further applicable to the LAS 140 managing access to particular equipment and/or services at a location. For example, according to an implementation, the LAS 140 manages access to particular meeting room equipment, such as an electronic whiteboard, overhead projector, sound system, etc., and/or services that are hosted on the meeting room equipment, such as electronic meeting services.

### III. REGISTERING USER IDENTIFICATION DATA AND GENERATING ENCODED DATA

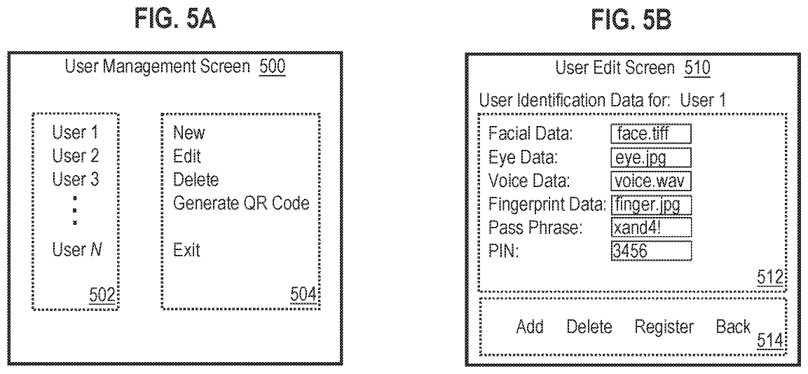

FIG. 4 is a message ladder diagram 400 that depicts messages exchanged between the elements in arrangement 100 to register user identification data and generate encoded data. Starting in step 402, a user at the client device 102 generates a request to manage registered user identification information and the request is sent to the user identification information registration service 302 on the identity validation manager 130. For example, the user uses a Web browser on the client device 102 to access the user identification information registration service 302 on the identity validation manager 130. Access to the user identification information registration service 302 may be conditioned upon a successful verification of user credentials provided by the user. For example, the user may be prompted to enter a user ID and password that must be successfully verified by the user identification information registration service 302, or another service executing either on the identity validation manager 130 or external to the identity validation manager 130. The user may be the end user for whom the encoded data is being generated, or may be another user such as an administrative user, meeting organizer, etc.

In step 404, the user identification information registration service 302 provides user interface data which, when processed at the client device 102, provides user interface data to allow the user to access the functionality of the user identification information registration service 302. For example, according to an implementation, the user identification information registration service 302 provides one or more Web pages to the client device 102 which, when processed by the client device 102, provide a graphical user interface that allows the user of the client device 102 to access the functionality of the identity validation manager 130, including the user identification information registration service 302. According to an implementation, the user identification information registration service 302 includes an Application Program Interface (API) to allow applications on the client device 102 to access the functionality provided by the Access to the user identification information registration service 302. This allows such applications to use their own customized user interface to access the user identification information registration service 302.

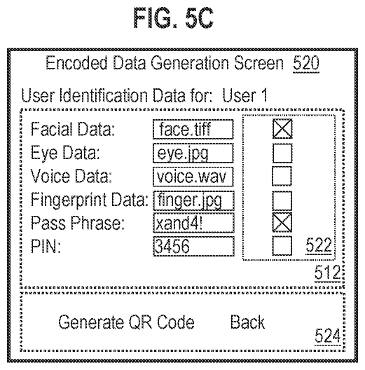

FIG. 5A depicts an example user management screen 500 according to an implementation. The user management screen 500 includes a list of registered users 502 on the user identification information registration service 302 and controls 504. According to an implementation, the users in the list of registered users 502 are selectable so that an action selected via the controls 504 applies to the selected user. The controls 504 allow new users to be added via the “New” control, or existing users to be edited via the “Edit” control or deleted via the “Delete” control.

FIG. 5B depicts an example user edit screen 510 that allows editing of current user data. The user edit screen 510 is displayed, for example, in response to a user selecting a user and then the “Edit” control from the controls 504 in the user management screen 500 of FIG. 5A. In the current example, it is presumed that “User 1” has been selected and the user edit screen 510 displays the user identification information specified for User 1 in a set of fields 512. According to an implementation, the fields 512 are selectable and editable to allow a user to add and change various user identification information, such as facial information, eye information, voice information, fingerprint information, a pass phrase, and a PIN for User 1. The facial information may represent an image of a user's face, either the entire face or at specified points, depending upon the particular facial data algorithm used, and implementations are applicable to any type of facial information and method for acquiring facial data. The eye information may be, for example, retina and/or iris information.

The particular user identification information and data formats depicted in FIG. 5B are for explanation purposes and the user identification information and data formats may vary from user to user. According to an implementation, when a data file is specified in a field 512, the user is presented with an option to upload the data file to the user identification information registration service 302.

A set of controls 514 allow new types of user identification information to be added. For example, in response to selection of the “New” control 514, a new field of user identification information is added to the fields 512 and the user allowed to define the field and specify identification information for the new field. The set of controls 514 also includes a “Delete” control 514 that allows a user to delete an existing field of user identification information by selecting a field and then the “Delete” control 514.

A “Register” control 514 causes the current user identification data to be registered with the user identification information registration service 302 and the current user identification information is saved in the registered user identification information 308. In response to a selection of the “Register” control 514, in step 408 (FIG. 4), the user identification information specified by the user is transmitted to the user identification information registration service 302 and stored in step 410. User identification information may be stored in any manner, e.g., location, data format, etc., and may vary depending upon a particular implementation. For example, user identification information may be stored locally on the identity validation manager 130 in one or more files, one or more databases, etc., and the user identification information may be stored in an unencrypted or encrypted manner. Alternatively, the user identification information may be stored external to the identity validation manager 130. A “Back” control 514 returns to the user management screen 500 of FIG. 5A. The registration of user identification data may be contingent upon the result of a verification process. For example, a user may be required to upload one or more government documents that have to be verified before user identification data is registered by the user identification information registration service 302.

Turning now to generating encoded data, in step 412, a request for a QR code is transmitted from the client device 102 to the encoded data generation service 304. According to an implementation, a request for a QR code is generated and transmitted after a user has specified the user identification information and validation methods to be included in the QR code. FIG. 5C depicts an example encoded data generation screen 520. The encoded data generation screen 520 includes the same fields 512 as the user edit screen 510 of FIG. 5B, except that selection boxes 522 are provided to allow the user to select the particular user identification information fields that are to be included in the QR code. In the example depicted in FIG. 5C, the user has selected the facial data and pass phrase information to be included in the QR code.

According to an implementation, the user identification information to be included in a QR code is specified by a security level, where different security levels specify different user identification information to be included in a QR code. For example, a security level hierarchy defines five levels, Level 1 through Level 5, where Level 1 is the least secure and Level 5 is the most secure. In this example, Level 1 requires only a PIN (least secure) while Level 5 (most secure) requires eye data, fingerprint data, and a pass phrase with minimum character requirements, e.g., a minimum length, at least one upper case and lower case letter, at least one number, and at least one special character. Level 5 security therefore provides stronger user identity validation that makes it much more difficult for a third party to successfully use a QR code that was generated for another user. Levels 2-4 require user identification data that is considered to be more secure than Level 1, but not as secure as Level 5.

The number of levels and the required user identification data for each level may be defined by a security policy for a group, business organization, etc. Thus, in the encoded data generation screen 520 of FIG. 5B, the selection boxes 522 for one or more of the user identification information fields 512 may be pre-selected and non-editable based upon a security level specified by a security policy for a business organization. The security level may also be specific to particular users. For example, employees at lower positions within a business organization may be assigned a security level of Level 1 while employees at high positions within the business organization are assigned a security level of Level 5. Thus, this approach provides great flexibility for organizations to define the strength of QR codes for different users.

Continuing with FIG. 5C, a set of controls 524 includes a “Generate QR Code” control which, when selected, causes a QR code to be generated that includes the selected user identification information. In response to a user selecting the “Generate QR Code” control 524, the client device 102 generates and transmits to the encoded data generation service 304 a request to generate a QR code for the selected user identification information.

In step 414, in response to the request, the encoded data generation service 304 generates a QR code that includes the selected user identification information and specifies one or more validation methods. For example, suppose that the selected user identification data includes facial information and a pass phrase. The encoded data generation service 304 generates a QR code that includes the facial data and the pass phrase. For example, the QR code may include an array of facial data points and the pass phrase. As another example, if the selected user identification data includes voice information, the QR code includes a voice data or a representation of the voice data, such as a signature generated from the voice data.

In situations where the size of the selected user identification information is too large to store in the QR code, the encoded data generation service 304 may generate multiple QR codes. For example, a first QR code contains a first portion of facial data and a second QR code contains a second portion of the facial data. According to another implementation, links to the selected user identification information are included in the QR code instead of the selected user identification information itself. In the prior example, the QR code includes the pass phrase and a link to the facial information, for example, a link to the facial data in the registered user identification information 308. QR codes may be encrypted for added security. For example, the controls 524 in the encoded data generation screen 520 of FIG. 5C may include a control for specifying that the QR code should be encrypted. When selected, the user is prompted for an encryption key, for example in the form of a pass phrase, to be used to encrypt the QR code.

According to another implementation, QR codes contain location and/or time-based constraints. The location-based constraints include, for example, one or more buildings, one or more rooms within a building, one or more venues, etc. The time-based constraints include, for example, one or more dates and/or times. According to an implementation, the encoded data generation screen 520 includes one or more graphical user interface controls that allow a user to specify one or more location and/or time-based constraints. This provides great flexibility to restrict the use of QR codes to particular locations and/or times, which is particularly beneficial when QR codes are used to validate users to allow access to particular locations. For example, a QR code may include a specified date so that when validated, it can only be used to access a particular location or venue on the specified date(s). According to an implementation, QR codes contain additional information. Examples of additional information include, without limitation, contact information for the user such as one or more of the user's name, phone number, email address, title or position within an organization, an affiliated business name, address, etc., and/or the contact information for one or more persons that the user is visiting. According to an implementation, QR codes include data that indicates how to communicate with the identity validation manager 130 for remote validation, as described in hereinafter. Examples of such data include, without limitation, a link or URL to the identity validation manager 130.

The one or more validation methods may be indicated by the QR code in different ways, depending upon a particular implementation. According to an implementation, the presence of certain types of user identification information in the QR code indicates the validation method. For example, the inclusion of facial data in a QR code indicates that facial data should be acquired and validated using the facial data in the QR code. Similarly, the inclusion of eye or voice data in the QR code indicates that eye or voice data, respectively, should be acquired and validated using the eye or voice data in the QR code, respectively. The inclusion of a pass phrase or PIN in a QR code indicates that a pass phrase or PIN should be acquired and validated using the pass phrase or PIN in the QR code. According to another implementation, a QR code includes data that indicates the validation method. For example, a QR code may include a data value that is used to lookup one or more validation methods in mapping data that maps lookup values to validation methods.

According to an implementation, generated QR codes are stored on the identity validation manager 130, for example, in the registered user identification information 308. Further, the generated QR code may be stored in association with the corresponding user and may also have a QR code ID, i.e., data that identifies the QR code. As described in more detail hereinafter, the QR code ID is useful when the computing device 120 is not able to perform local user validation and instead uses the identity validation service 306 to validate the identity of a user. According to an implementation, an option is provided to generate an encrypted QR code. QR codes may be encrypted using any encryption methodology and implementations are not limited to any particular type of encryption methodology. Also, previously generated QR codes may be requested and obtained from the encoded data generation service 304. In FIG. 5C, the controls 524 also include a “Back” control which, when selected, returns control to the user management screen 500 of FIG. 5A. In step 416, the encoded data generation service 304 provides the QR code to the client device 102. This may be accomplished via messaging, email, etc. The QR code may then be printed by the user of the client device 102, stored on a mobile phone of the user, etc. In the situation where the user is an administrative user or a meeting organizer requesting a QR code on behalf of another user, the user can provide the QR code to the user via, for example, email, a meeting invitation, etc.

Although implementations are depicted in the figures and described herein in the context of using the encoded data generation screen 520 of FIG. 5C to generate QR codes, implementations are not limited to this example. According to an implementation, an application on the client device 502 issues a request to the encoded data generation service 304 to generate a QR code. The request identifies a user and one or more types of user identification information to be included in the QR code, and optionally specifies whether the QR code is to be encrypted and if so, an encryption key. For example, the request specifies User 1, voice information in the form of voice data or a link to voice data, a pass phrase, and optionally an encryption key. For public key encryption, an encryption key does not need to be included in the request. The encoded data generation service 304 generates the requested QR code and returns it to the application on the client device 102.

### IV. VALIDATING USER IDENTIFICATION DATA

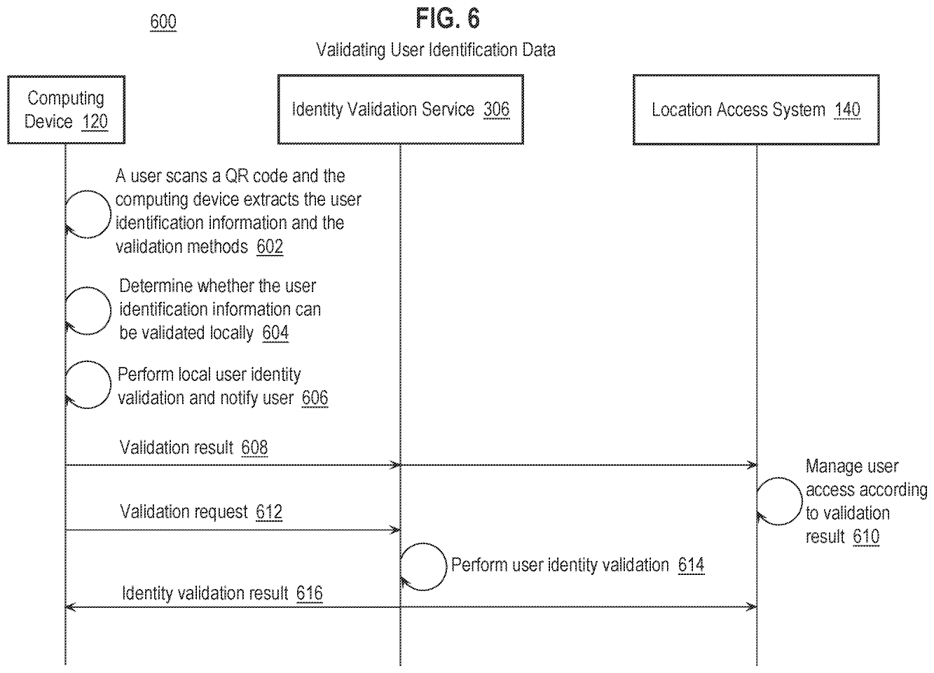

FIG. 6 is a message ladder diagram 600 that depicts messages exchanged between the elements in arrangement 100 to validate user identification data. In step 602, a user scans a QR code at a computing device 120 and the computing device extracts the user identification information and the validation methods from the QR code. For example, in the context of the computing device 120 being a kiosk, a user scans a QR code using the data acquisition component 202 of the kiosk and the local identity validation service 212 extracts the user identification information and the validation methods from the QR code. This may include performing decryption for situations where the QR code is encrypted. The QR code may be printed on a physical medium or displayed on an electronic device, such as a mobile phone, and presented to the data acquisition component 202 of the kiosk. As previously described herein, the validation methods may be determined based upon the type of user identification contained in the QR code or by data in the QR code that specifies the validation methods.

In step 604, the computing device 120 determines whether the user identification information can be validated locally at the computing device 120. According to an implementation, the local identity validation service 212 determines whether the kiosk has the capability, i.e., the necessary equipment and functionality, to validate the user identification information extracted from the QR code. For example, suppose that a QR code contains facial information that is generated by processing facial image data using a particular algorithm. An example algorithm samples a facial image at specified points and generates an array of values that represents the facial image, but with much less data. In this example the local identity validation service 212, or some other element on the computing device 120, determines whether the local identity validation service 212 is configured with the particular algorithm to process facial image data acquired by the computing device 120. As another example, suppose that a QR code contains voice information that is generated by a particular algorithm that processes voice data for an utterance and generates a voice signature. In this example the local identity validation service 212, or some other element on the computing device 120, determines whether the local identity validation service 212 is configured with the particular algorithm to process voice data acquired by the computing device 120.

Assuming that the computing device 120 has the capability to locally validate the user identification information, then in step 606, the computing device 120 locally validates the user identification information. For example, suppose that the user identification information includes facial information and a pass phrase. The local identity validation service 212 causes the data acquisition component 202 to acquire facial information of the user. This may include the local identity validation service 212 prompting the user via the display 204 and/or the speaker 206 to move in front of a camera so that an image of the user can be acquired. For example, the local identity validation service 212 may cause one or more direction icons to be displayed on the display 204 and one or more voice commands to be communicated to the user via the speaker 206. Once a facial image of the user has been acquired, the local identity validation service 212 performs any required processing of the acquired facial image and compares the acquired facial information, or the processed facial information, to the facial information in the QR code.

Since in this example the user identification information in the QR code also includes a pass phrase, the local identity validation service 212 prompts the user to enter a pass phrase via the data acquisition components 202, such as a keyboard or keypad. The user enters a pass phrase and the local identity validation service 212 compares the pass phrase entered by the user to the pass phrase contained in the QR code. If both the acquired facial information is the same as the facial information contained in the QR code, after any required processing, and the pass phrase entered by the user is the same as the pass phrase contained in the QR code, then the user is considered to be validated.

After completing the local user identity validation, the computing device 120 communicates the validation result to the user. For example, the computing device 120 communicates the validation result to the user by displaying information via the display 204 and/or communicating sound information via the speaker 206. As another example, the computing device 120 sends a message to the user via the user's personal computing device, such as a mobile phone. Also, in step 608 the computing device 120 communicates the validation result to the identity validation service 306 for logging. The validation result is also sent to the location access system 160 for processing in step 610. According to an implementation, the validation result sent to the location access system 160 includes any location and time constraints in the QR code to enable the location access system 160 to determine whether to allow access by the user in step 610. For example, in the case of a positive, i.e., successful, validation result, the location access system 160 grants access to one or more locations, subject to any constraints in the QR code. Conversely, in the case of a negative validation result, the location access system 160 denies the user access to one or more locations.

If in step 604 the computing device 120 determines that the user identification information cannot be validated locally at the computing device 120, then in step 612, the computing device 120 sends a validation request to the identity validation service 306. The validation request includes the user identification information and validation methods acquired by the computing device 120. Continuing with the prior example, the validation request includes the facial information and voice information acquired from the user by the computing device 120. The validation request also includes the user identification information from the QR code or data that identifies the QR code, such as the QR code ID previously discussed, and the validation methods, to allow the identity validation service 306 to acquire the user identification information from the QR code stored on the identity validation service 306 and validate the user identification information. As previously described herein, QR codes may contain data, such as a link, URL, etc., that is used for remote validation. For example, the QR code includes a link or a URL to the identity validation service 306.

In step 614, the identity validation service 306 validates the user identification information acquired by the computing device 120 using the user identification information in the QR code. In step 616, the identity validation service 306 transmits an identity validation result to the computing device 120 and the location access system 160 for processing as previously described above. For example, the computing device 120 notifies the user of the computing device 120 of the validation result by displaying information via the display 204 and/or communicating sound information via the speaker 206. The location access system 160 uses the validation result to manage access to one or more locations.

Although implementations are described herein and depicted in the figures in the context of the computing device 120 acquiring a QR code from a user by scanning a QR code, implementations are not limited to these examples. According to an implementation, a QR code is acquired by the computing device 120 from the client device 110 using NFC. In this implementation, the client device 110 and the computing device 120 are configured with NFC capability. For example, the client device 110 and the computing device 120 are both configured with an NFC interface. When the client device 110 is in close proximity to the computing device 120, the client device 110 establishes a wireless connection with the computing device 120 via NFC and transmits the QR code to the computing device 120, e.g., by sending the QR code data into the QR code to the computing device 120. For example, a user validation application executing on the client device 110 detects the presence of the computing device 120, establishes a wireless connection with the computing device 120 via NFC, and transmits the QR code to the computing device 120. This alleviates the user from having to scan the QR code at the computing device 120.

### V. IMPLEMENTATION EXAMPLES

According to one implementation, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that are persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

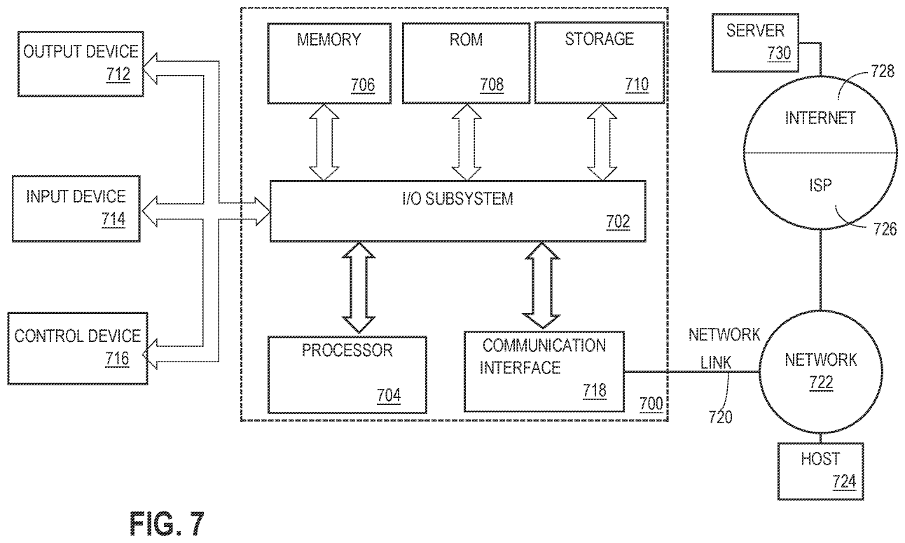

FIG. 7 is a block diagram that illustrates an example computer system. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disk such as CD-ROM or DVD-ROM, and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708 or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 700 may be coupled via I/O subsystem 702 to at least one output device 712. In one implementation, output device 712 is a digital computer display. Examples of a display that may be used in various implementations include a touch screen display or a light-emitting diode (LED) display or a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

At least one input device 714 is coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on display 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another implementation, computer system 700 may comprise an internet of things (IoT) device in which one or more of the output device 712, input device 714, and control device 716 are omitted. Or, in such an implementation, the input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware and interfaces for generating position reporting packets, notifications, pulse or heartbeat signals, or other recurring data transmissions that specify a position of the computer system 700, alone or in combination with other application-specific data, directed toward host 724 or server 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one implementation, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative implementation, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to bus 702. Communication interface 718 provides a two-way data communication coupling to network link(s) 720 that are directly or indirectly connected to at least one communication networks, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a local area network (LAN), wide-area network (WAN), campus network, internetwork or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server 730 broadly represents any computer, data center, virtual machine or virtual computing instance with or without a hypervisor, or computer executing a containerized program system such as DOCKER or KUBERNETES. Server 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server 730 may form elements of a distributed computing system that includes other computers, a processing cluster, server farm or other organization of computers that cooperate to perform tasks or execute applications or services. Server 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 730 may comprise a web application server that hosts a presentation layer, application layer and data storage layer such as a relational database system using structured query language (SQL) or no SQL, an object store, a graph database, a flat file system or other data storage.

Computer system 700 can send messages and receive data and instructions, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an implementation, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an implementation, for security and reliability, an operating system may prevent direct communication between independent processes, providing strictly mediated and controlled inter-process communication functionality.

1. A computing device comprising:
one or more data acquisition components configured to:
acquire encoded data that contains first user identification information and data that specifies one or more validation methods to validate the first user identification information, and
acquire second user identification information of a user at the computing device,
wherein the computing device is configured to cause the second user identification information to be validated using the first user identification information and the one or more validation methods.

2. The computing device as recited in claim 1, wherein the computing device is further configured to validate the second user identification information using the first user identification information and the one or more validation methods.

3. The computing device as recited in claim 1, wherein the computing device is further configured to:
process the second user identification information to generate processed second user identification information, and
validate the second user identification information by comparing the processed second user identification information to the first user identification information according to the one or more validation methods.

4. The computing device as recited in claim 1, wherein the computing device is further configured to generate and transmit a request to an identity validation service to validate the first user identification information.

5. The computing device as recited in claim 4, wherein the request includes: a) the first user identification information and the second user identification information to be transmitted to the identity validation service for validation according to the one or more validation methods.

6. The computing device as recited in claim 1, wherein:
validation of the second user identification information generates a validation result that indicates whether the validation was successful, and
the computing device is further configured to send the validation result to a location access system to grant the user access to one or more locations or venues based upon the validation result.

7. The computing device as recited in claim 1, wherein the one or more data acquisition components include one or more of a scanner, an image acquisition device, a microphone, a keyboard, a keypad or a Near Field Communications (NFC) interface.

8. The computing device as recited in claim 1, wherein the encoded data is one or more of one or more bar codes, one or more encrypted bar codes, one or more Quick Response (QR) codes, or one or more encrypted QR codes.

9. The computing device as recited in claim 1, wherein the first user identification information includes one or more of facial information, eye information, voice information, finger or hand information, DNA information, a pass phrase, or a personal identification number.

10. The computing device as recited in claim 1, wherein the second user identification information of the user at the computing device includes biometric information of the user and non-biometric information from the user.

11. The computing device as recited in claim 1, wherein the encoded data specifies one or more of: one or more locations for which the encoded data is valid, one or more dates for which the encoded data is valid, or one or more times for which the encoded data is valid.

12. The computing device as recited in claim 1, wherein:
the first user identification information includes two or more different types of user identification information, and
the one or more validation methods include a different validation method for each type of user identification information from the two or more different types of user identification information.

13. A computing device comprising:
an identity validation service executing on the computing device, the identity validation service being configured to:
receive user identification information acquired by a second computing device from a user at the second computing device, and
validate the user identification information acquired by the second computing device from the user at the second computing device using user identification information and one or more validation methods from encoded data.

14. The computing device as recited in claim 13, wherein the computing device is further configured to:
process the user identification information acquired by the second computing device from the user at the second computing device to generate processed user identification information, and
validate the user identification information acquired by the second computing device from the user at the second computing device by comparing the processed user identification information to the user identification information according to the one or more validation methods.

15. The computing device as recited in claim 13, wherein:
validation of the user identification data acquired by the second computing device from the user at the second computing device generates a validation result that indicates whether the validation was successful, and
the computing device is further configured to send the validation result to a location access system to grant the user access to one or more locations or venues based upon the validation result.

16. The computing device as recited in claim 13, wherein the encoded data is one or more of one or more bar codes, one or more encrypted bar codes, one or more Quick Response (QR) codes, or one or more encrypted QR codes.

17. The computing device as recited in claim 13, wherein the user identification information includes one or more of facial information, eye information, voice information, finger or hand information, DNA information, a pass phrase, or a personal identification number.

18. The computing device as recited in claim 13, wherein the user identification information acquired by the second computing device from the user at the second computing device includes biometric information of the user and non-biometric information from the user.

19. The computing device as recited in claim 13, wherein the encoded data specifies one or more of: one or more locations for which the encoded data is valid, one or more dates for which the encoded data is valid, or one or more times for which the encoded data is valid.

20. The computing device as recited in claim 13, wherein:
the user identification information includes two or more different types of user identification information, and
the one or more validation methods include a different validation method for each type of user identification information from the two or more different types of user identification information.
